(19) United States
(12) Patent Application Publication
(10) Pub. No.: US 2022/0149700 A1
(43) Pub. Date: May 12, 2022

(54) MULTI-FAN MOBILE GAS GENERATOR COOLING SYSTEM

(71) Applicant: STEWART & STEVENSON LLC, Houston, TX (US)

(72) Inventor: Brian Sharp, Houston, TX (US)

(21) Appl. No.: 17/516,853

(22) Filed: Nov. 2, 2021

Related U.S. Application Data
(60) Provisional application No. 63/110,798, filed on Nov. 6, 2020.

(51) Int. Cl. H02K 9/18; E21B 43/26; H02K 7/18

(52) U.S. Cl. CPC H02K 9/18; H02K 7/1815; E21B 43/26

(57) ABSTRACT

An efficient, low-noise power generation system may comprise a power generation trailer including a cooling subsystem. The cooling subsystem may include a plurality of cooling fans and a polygonal structure having an open top. The polygonal structure may comprise a plurality of vertical radiator cores arranged so as to form a polygon in which the plurality of radiator cores define side walls. The cooling fans may be mounted within the polygonal structure. The cooling subsystem may include a cooling fan motor for each fan and a cooling fan controller that controls operation of each cooling fan motor in response to at least one measured parameter, which may be the temperature of a fluid flowing through one or more radiator cores. At least one fan is oriented so as to push air out of the top of the polygonal structure. The polygonal structure may have four sides.

### CROSS-REFERENCE TO RELATED APPLICATIONS

This application is a nonprovisional application which claims priority from U.S. provisional application No. 63/110,798, filed Nov. 6, 2020, which is hereby incorporated by reference herein in its entirety.

### TECHNICAL FIELD/FIELD OF THE DISCLOSURE

The present disclosure relates to wellsite equipment, specifically to wellsite equipment used for hydraulic fracturing.

### BACKGROUND OF THE DISCLOSURE

Hydraulic fracturing, referred to herein as fracking, is a method used to enhance hydrocarbon recovery from certain downhole formations. Fracking involves the injection of high-pressure fluid into the downhole formation to induce fracturing of the formation. A proppant is typically included in the fluid used for fracturing. The proppant enters the fractures and retards the closure of the fractures once the fracking operation is completed. The fractures produced may provide additional flow channels for hydrocarbons to escape the formation.

Multiple pieces of wellsite equipment are used during a fracking operation, including pumps used to supply the fracturing fluid to the formation, referred to herein as frac pumps. Frac pumps may be driven by electric or diesel motors. Electrical power for the frac pump motors may be generated onsite by a generator, which may be a gas-powered generator. Frac pumps and the associated equipment may require a cooling system.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a perspective view of a power generation trailer consistent with at least one embodiment of the present disclosure.

FIG. 2 is a perspective view of a multi-sided multi-fan mobile gas generator cooling system in accordance with at least one embodiment of the present disclosure.

FIG. 3 is a perspective top view of a multi-sided multi-fan mobile gas generator cooling system in accordance with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The present disclosure hereby includes the concepts and features described in U.S. application Ser. No. 16/885,940, filed May 28, 2020 and entitled “Integrated Fracking System”, US. Application Ser. No. 62/935,542, filed Nov. 14, 2019 and entitled “Well Servicing Pump with Electric Motor”, and U.S. application Ser. No. 17/064,155, filed Oct. 6, 2020 and entitled “Wellsite Adaptive Power Management System”, each of which is hereby incorporated herein in its entirety.

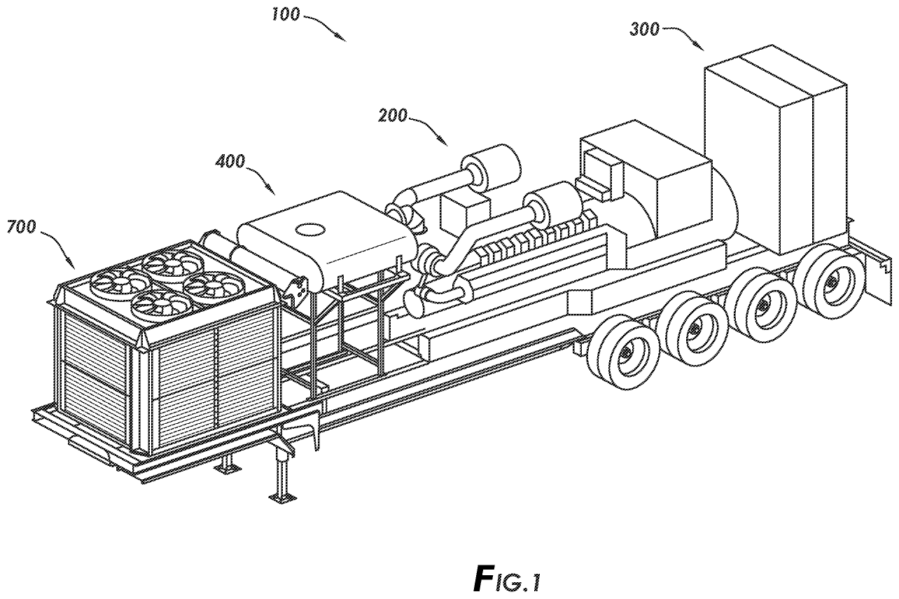

FIG. 1 depicts power generation trailer 100 including, for example and without limitation, generator 200, switchgear module 300, exhaust silencer system 400, and cooling subsystem 700. In certain embodiments, generator 200, switchgear module 300, exhaust silencer system 400, and cooling subsystem 700 may be mounted on a trailer for transportation to and from a wellsite.

Switchgear module 300 may distribute power from generator 200 to multiple systems such as power distribution units, fracturing pumps, slurry pumps and other units. Exhaust silencer system 400 may be fluidly coupled to generator 200 and configured so as to receive exhaust gases generated thereby.

In some embodiments, cooling subsystem 700 may include one or more closed-loop cooling circuits configured to provide temperature control for various equipment. The use of a cooling circuit may allow for quieter operations as compared to a traditional air-cooled operation, in that air-cooled systems typically rely on one or more blowers to move air through the equipment. By using a cooling circuit, the noise of such blowers may be eliminated.

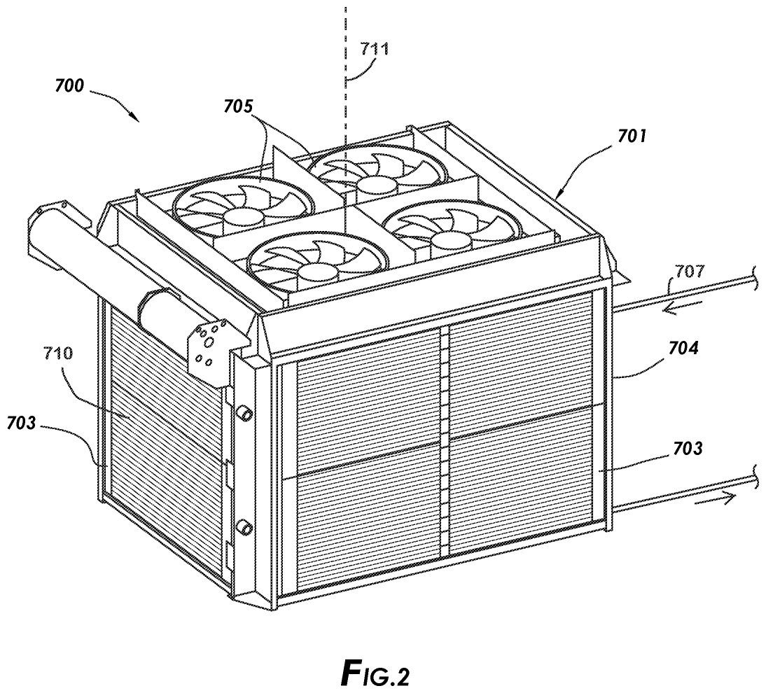

In some embodiments, a cooling circuit may include coolant flow lines extending between cooling subsystem 700 and the equipment to be cooled. In some embodiments, the coolant may comprise water or may be at least partially glycol-based. The coolant may circulate between the equipment to be cooled and the cooling subsystem 700 through coolant flow lines 707 (FIG. 2). In some embodiments, cooling subsystem 700 may include a coolant pump (not shown), which may operate to circulate the coolant. In some embodiments, coolant may absorb heat as it travels through the equipment to be cooled and may release heat as it travels through cooling subsystem 700.

In some embodiments, a cooling circuit may optionally include one or more heating elements. The heating elements may be immersion heating elements and may be adapted to heat coolant as it circulates. In some embodiments, such heating may be used to, for example and without limitation, mitigate a risk of condensation, clogging, or seizing that might otherwise result from ambient conditions.

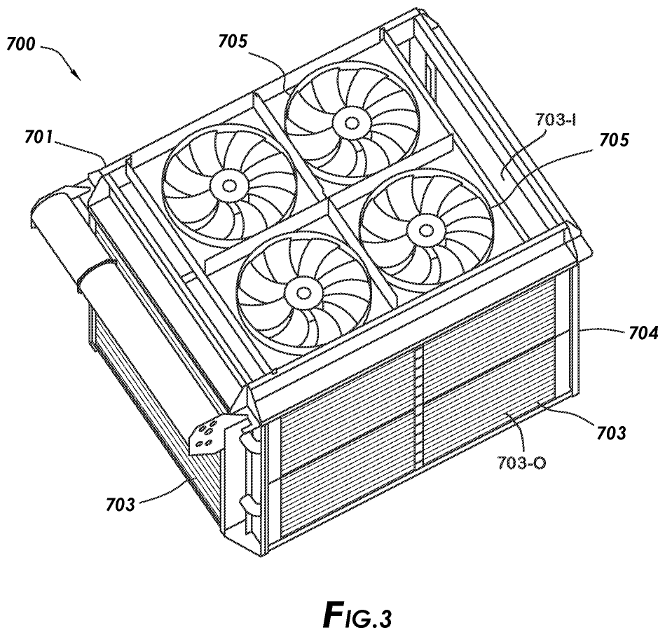

Referring now to FIGS. 2 and 3, cooling subsystem 700 may include one or more radiator cores 703 and one or more cooling fans 705. Cooling subsystem 700 may include a polygonal structure having an axis 711, a plurality of side walls 710, and an open top. At least one cooling fan may be mounted on or within the polygonal structure. At least one of the side walls 710 may comprise at least one vertical radiator core. In some embodiments, a plurality of vertical radiator cores 703 is arranged so as to form a polygonal structure 701 in which radiator cores 703 define the side walls. Polygonal structure 701 may have four side walls 710, as in the illustrated embodiment, or may have a different number of sides. Axis 711 may be substantially vertical, as in the illustrated embodiment. Each side wall may be formed from one or more radiator cores 703. Structure 701 may include a frame 704 to support radiator cores 703 in the desired configuration. In the illustrated embodiment, cooling subsystem 700 comprises a four-sided structure 701. The number and arrangement of the side walls may be varied.

One or more cooling fans 705 may be positioned within structure 701 or adjacent to structure 701. At least one of cooling fans 705 may be oriented normal to axis 711 and configured to push air upward (as drawn), out of cooling subsystem 700. In some embodiments, one or more cooling fans 705 may together define a substantially planar unit that is perpendicular to the side walls of structure 701 and normal to axis 711. While cooling fans 705 are at or near the top of the structure in FIGS. 2 and 3, in other embodiments cooling fans 705 may be positioned lower within the structure or may be positioned differently. Structure 701 may have a substantially open top, i.e. air flowing into structure 701 through radiator cores 703 is able exit structure 701 via the top (as drawn) face of structure 701. The number and configuration of cooling fans 705 may also be varied. For example, in some embodiments, cooling subsystem 700 may include from two to ten cooling fans 705. In some embodiments, only one cooling fan 705 is used.

Frame 704 may be adapted to allow removal and replacement of radiator cores 703. The fluid flow lines connecting each moveable radiator core to its respective cooling loop may be flexible and may include quick-release fluid connections.

Access to the inside of cooling structure 701 may be desirable for purposes of inspection, maintenance, and/or repair. In the illustrated embodiment, the inside of structure 701 is accessible via the bottom of the structure 701. In some embodiments, the bottom of the cooling structure 701 and/or the interface between the bottom face of the cooling structure 701 and the supporting structure beneath cooling structure 701 may be enclosed and/or sealed, so as to prevent air from entering through the bottom of structure 701 and ensure that air entering structure 701 flows through the side walls 710, i.e. through radiator cores 703. The enclosure may be adapted to allow access to the inside of structure 701. By way of example, the bottom face of cooling structure may include an access port.

In some embodiments, it may be desirable to increase the heat transfer capacity of cooling subsystem 700 by increasing its surface area by including, for example, additional radiator cores 703. In one such embodiment, the bottom face of structure 701 may include additional radiator cores 703. In some embodiments, a portion of frame 704 supporting one or more radiator cores 703 may be adapted to allow access to the inside of structure 701. By way of example only, one or more radiator cores 703 may slide or swing out of the way. In such embodiments, the fluid flow lines connecting each moveable radiator core to its respective cooling loop may be flexible to accommodate such movement, and/or may include quick-release fluid connections.

Radiator cores 703 are each a generally planar structure having inner and outer faces 703-I, 703-O, respectively, and comprising a plurality of manifolded tubes. When two or more radiator cores 703 are included in a cooling loop, they can be arranged in series or in parallel. Radiator cores 703 may be configured so that fluid enters each core at the top and leaves at the bottom, or vice versa. Radiator cores are also configured so that air can flow through each core, typically in a direction substantially normal to the plane of the core, allowing heat transfer between the air and the coolant in the core(s). In some embodiments, air enters each core through outer face 703-O and leaves through inner face 703-I.

Depending on ambient conditions and the temperature of coolant as it enters radiator core 703, cooling fan(s) 705 may be operated to provide forced convection through radiator core(s) 703, thereby increasing the cooling rate of coolant as it passes through radiator core 703. Operation of cooling fans 705 reduces the air pressure inside structure 701, which in turn causes air to flow into structure 701 through radiator cores. When the coolant inside radiator cores 703 is warmer than the ambient air temperature, the air flowing through each radiator core 703 will absorb heat from the coolant, thereby cooling the coolant.

Each cooling fan 705 may be driven by a cooling fan motor (not shown), which may be a constant speed or variable speed motor. In some embodiments, the cooling fan motor may be controlled by a cooling fan controller which may, in some embodiments, control the operation of the cooling fan motor in response to one or more variables including, for example and without limitation, the measured temperature of a fluid flowing through one or more radiator cores.

In some embodiments cooling subsystem 700 may be configured to maintain the measured temperature within one or more pre-programmed temperature ranges. In embodiments in which the cooling fan motor is a variable speed motor, the cooling fan controller may vary the speed of rotation of cooling fan(s) 705 in response to the one or more variables.

In embodiments in which more than one cooling circuit is used, the plurality of radiator cores 703 may be distributed between the cooling circuits as desired. By way of example, if it is determined that one cooling circuit will be required to eliminate more heat than another cooling circuit, more of the plurality of radiator cores 703 may be included in the former.

Because of the flexibility and capacity of cooling subsystem 700, cooling subsystem 700 can provide cooling for a range of operations and equipment types. Cooling subsystem 700 may, for example and without limitation, reduce the overall noise output and energy requirements, as compared to systems using other cooling devices.

1. A power generation system comprising:
a power generation trailer including a cooling subsystem thereon;
wherein the cooling subsystem includes at least one cooling fan and a polygonal structure having an axis, a plurality of side walls, and an open top;
wherein at least one of the side walls comprises at least one vertical radiator core; and
wherein the at least one cooling fan is mounted within the polygonal structure.

2. The power generation system of claim 1 wherein at least one cooling fan is oriented so as to push air out of the top of the polygonal structure.

3. The power generation system of claim 2 wherein the cooling subsystem further includes a cooling fan motor for each cooling fan and a cooling fan controller, wherein the cooling fan controller controls operation of each cooling fan motor in response to at least one measured parameter.

4. The power generation system of claim 3 wherein the cooling fan controller controls operation of each cooling fan motor in response to a measured temperature of a fluid flowing through one or more radiator cores.

5. The power generation system of claim 3 the system is configured to prevent air from entering through the bottom of the polygonal structure and ensure that air entering the polygonal structure flows through the radiator cores.

6. The power generation system of claim 2 wherein the system includes a plurality of cooling fans and the cooling fans define a substantially planar unit that is normal to the axis of the polygonal structure.

7. The power generation system of claim 6 wherein the polygonal structure includes a bottom face and wherein the bottom face of cooling structure includes an access port, whereby the inside of the polygonal structure is accessible via the bottom of the polygonal structure.

8. The power generation system of claim 6 wherein the bottom of the polygonal structure includes at least one additional radiator core.

9. The power generation system of claim 6 wherein a side of the structure is moveable so as to provide access to the inside of the structure.

10. The power generation system of claim 6 wherein at least one radiator cores is adapted to slide or swing into an open position so as to allow access to the inside of structure.

11. The power generation system of claim 10 wherein fluid flow lines connect the at least one radiator core to its respective cooling loop, and wherein the fluid flow lines include quick-release fluid connections.

12. The power generation system of claim 6 wherein the cooling subsystem uses less energy and emits less noise than a single-fan cooling system providing the same heat transfer capacity.

13. The power generation system of claim 1 wherein the cooling subsystem includes at least two cooling loops and the radiator cores are distributed between the cooling loops.

14. The power generation system of claim 13, further including a control system whereby the distribution of the radiator cores between the cooling loops can be modified without interrupting operations.

15. The power generation system of claim 1, wherein the power generation trailer includes:
a generator;
a switchgear in electrical connection with the generator; and
an exhaust silencer connected to the generator.

16. The power generation system of claim 15, wherein the cooling system is configured to cool the generator.

17. The power generation system of claim 15, wherein the switchgear, the generator, the exhaust silencer, and the cooling subsystem are mounted on a trailer.
